(19) United States
(12) Patent Application Publication
(10) Pub. No.: US 2002/0149216 A1
(43) Pub. Date: Oct. 17, 2002

(54) Lifting device and stress sensor therefor

(76) Inventor: Manuel Teixeira, Gourdon (FR)

Correspondence Address: Ira J. Schultz, DENNISON, SCHEINER & SCHULTZ, Suite 612, 1745 Jefferson Davis Highway, Arlington, VA, 22202, US

(21) Appl. No.: 10/085,131

(22) Filed: Mar. 1, 2002

(30) Foreign Application Priority Data
Mar. 2, 2001 (FR) 01 02 865

(51) Int. Cl. B66C 13/16

(52) U.S. Cl. 294/82.1; 294/907

(57) ABSTRACT

A lifting device for handling of loads by suspension, especially maritime containers, includes:

an attaching body (21) including axial guidance and immobilization means (35, 36) and rotation guiding means (23),

a gripping device (24) passing through the body, in which it is held by the guidance and immobilization means and which, on the outside of the body, includes a coupling end (26) with an alternating rotation drive transmission (28) and opposite it, the shouldered head (30),

and a stress sensor (40) measuring the traction applied to the seizing device after coupling with the mortise, during container lifting and handling operations.

### BACKGROUND OF THE INVENTION

The present invention concerns the field of machines, installations and/or devices for lifting, intended to handle heavy loads, and concerns more particularly but not exclusively lifting machinery of the mobile and self-propelled type which, as handling equipment, use a lifting beam supported by a suspension.

As a preferred but non-limitative application, the invention refers more particularly to the area of container lifting and handling machinery, as is often used in seaport loading and unloading areas through which heavy loads are routed and handled, in particular rectangular box-shaped containers which it is necessary to be able to move, transport, lift, lower and stack with optimum safety.

In the general area described above, more particularly involved in maritime applications, it is customary to use lifting-handling machinery, generally self-propelled, of the tracked or wheeled type and which have, on a suitable superstructure, a suspension lifting beam which is orientable and generally adjustable in several directions so as to be adaptable to standardized or other gauges of the loads to be handled.

In the particular application case of maritime transport containers, the lifting beam is mounted at the end of a beam or boom, telescopic or not. To ensure the required function, it is obviously necessary to provide for technical facilities making it possible to establish or break at will the material structural link between the suspension lifting beam and the load, in particular the container.

The means described in brief in the above are well known and can be considered as satisfactory for the essential function of lifting and handling.

The current trends of container handling are generating the use of increasingly heavy loads varying from one container to another, even if the gauge is the same. Therefore, a particular problem to be taken into consideration is the exact evaluation of the weight of each container so as to be able to determine accurately the safety factor, both for the lifting and handling machine and for the principle of centering and loading, especially for loading on a ship.

That is why it is increasingly essential to carry out individual weighing for each load so as to evaluate whether the safety factor and the weight are not exceeded, and whether particular steps have to be considered concerning lifting, handling, loading, centering or, yet again, capabilities of vertically stacking several containers of the same gauge size.

These weighing operations are lengthy, requiring the use of a scale, which are not conducive to easy movement of the lifting and handling machines, in particular for loading and unloading areas or those used for storage of these containers, meaning frequently picking up operations and in all, representing a major factor that has an impact on the economic balance of the lifting and handling phase.

In addition, these necessary and different operations are not liable to supply sufficient accuracy, meaning that the invoicing of the service related to the weighing-handling task is penalized similarly.

That is why it has been recommended to adapt the methods of evaluation of the weight to the lifting and handling machine so as to obtain, immediately and in real time, information that covers the general concern mentioned in the above.

To do this, in general, it has been recommended to use stress-sensing facilities, for instance, directly on the lifting actuators for a boom, which facilities, themselves well known, react immediately with the weight that the machine is desired to lift in suspension.

Experiments carried out on the above basis have indicated that the principle referred to did not give sufficiently accurate information about the loaded weight. This inaccuracy is probably due to the distance between the point of suspension of the load, for instance at the end of the boom and the lifting machines, which distance, by a mechanical stress, induces inaccurate evaluations, giving incorrect estimations which, by accumulation, can result in situations that are outside safety standards and are liable to cause accidents that could result in human injury. In addition, this inaccuracy is no longer acceptable considering the relatively high price of the lifting-handling service to be provided for third parties.

It is noteworthy that a problem of the same type arises in measuring the loads transported by the lifting hook of a crane, for instance a telescopic one.

### SUMMARY OF THE INVENTION

Therefore, the purpose of the invention is to address the need that is currently being experienced of having, in real time, accurate information about the weight being lifted, while simply bringing in adaptations of technical means which were previously combined to handle the task of lifting-handling from known types of machines.

To achieve the above objective, the purpose of the invention is a stress sensor for a lifting and/or handling device including a lifting device equipped with an attaching for a “suspended” load, is characterized in that it includes:

a support body and a bearing cap which, together, define at least one fluid compression chamber and are designed to be interposed,

pressure measuring facilities within the compression chamber.

According to one characteristic of the invention, the support body and the bearing cap have a hole designed to accommodate a suspension rod of the attaching device.

According to another characteristic of the invention, the compression chamber is annular in a shape. In a preferred but not strictly essential manner, the compression chamber and the reception bore of the suspension rod are then more or less coaxial.

Another purpose of the invention is a lifting device for a lifting-handling machine including at least one attaching body equipped with a load attaching device, characterized in that it includes a stress sensor according to the invention, interposed between the attaching body and the attaching device.

According to one embodiment of the invention, the lifting device forms a rotary attaching weighing lock for a container lifting-handling machine load take-up lifting bar characterized in that:

the attaching body has means of guiding and immobilization of the guide facilities in rotation in the axial direction,

the attaching device has a rod, generally cylindrical in shape, passing through the attaching body and the stress sensor, retained by guide and immobilization facilities and which include, outside the body, a coupling end-fitting with an alternating drive transmission and on the opposite end, a shouldered head designed to cooperate with the oblong mortise shape of the container.

In another embodiment of the invention, the lifting device is a crane hook characterized in that:

the attaching body has axial guidance and immobilization means and rotation guidance means,

the attaching device includes a hook extending in a rod passing through the body and the stress sensor in which it is maintained by immobilization and guide means and which, opposite the hook, has a bearing head on the stress sensor cap, inserted between the attaching body and the attaching device.

### BRIEF DESCRIPTION OF THE DRAWINGS

Various other characteristics are described below with reference to the attached illustrations which, as non-limitative examples, depict the embodiments of the object of this invention.

FIG. 1 is a schematic side elevation view of a lifting-handling machine, in particular for containers.

FIG. 2 is a schematic plan view approximately along the line II-II of FIG. 1.

FIG. 3 is a schematic elevation view similar to FIG. 1 but illustrating a phase for the commissioning of the lifting-handling machine.

FIG. 4 is a partial perspective view showing, at a larger scale, a detail of the method used in one of the components of the lifting-handling machine according to FIGS. 1 to 3.

FIG. 5 is a perspective view showing at a larger scale the objects of the invention.

FIG. 6 is a sectional view approximately according to drawing VI-VI of FIG. 5.

FIG. 7 is a particularly cutout elevation view of another form of implementation of a stress sensor according to the invention on a lifting hook equipped with a crane sheave.

FIG. 8 is a sectional view similar to FIG. 6, but illustrating at a larger scale the implementation of a stress sensor on the crane hook.

FIG. 9 illustrates the implementation of a stress sensor according to the invention, on a simple crane hook without a shave.

### DESCRIPTION OF THE PREFERRED EMBODIMENTS

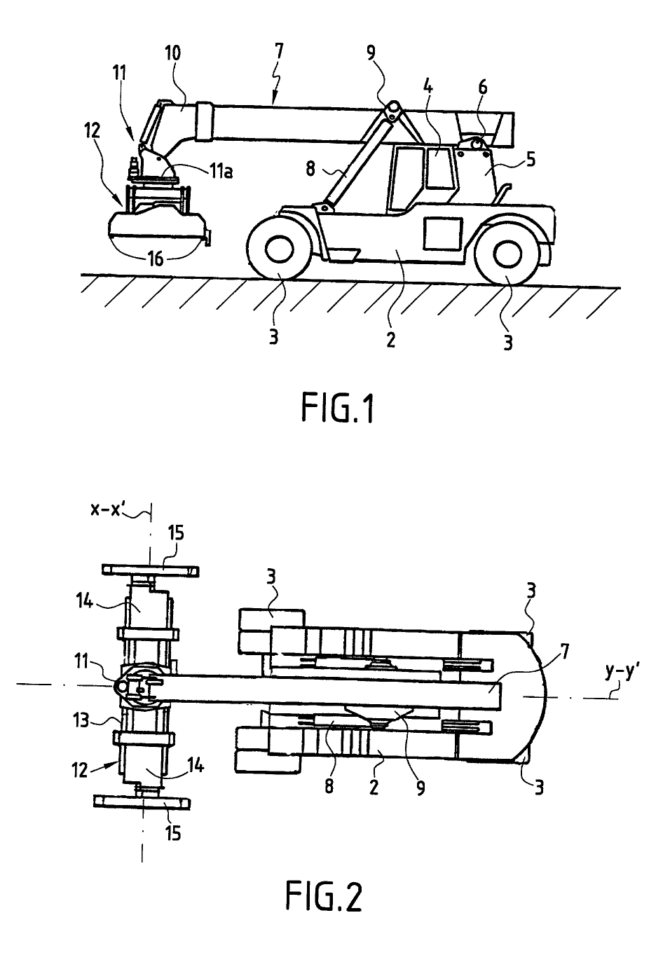

FIGS. 1 and 2 show, as an application example, a lifting-handling machine described generally by reference 1. A machine like this includes a chassis 2 supported by independent means of movement such as wheels 3, or yet again tracks that are not shown, which means are made self-propelling by means of any appropriate motorization system. Chassis 2 supports a control cab 4 and a structure, or even a bearing superstructure 5 on which a jib 7, normally oriented in the longitudinal plane of symmetry of chassis 2, is articulated by a horizontal shaft 6. However, it should be considered that in some cases, structure 5 may consist of a tower, which is then adjustable through a vertical axis.

Jib 7 may be telescopic or not and may be adjusted in elevation by swiveling about axis 6 by means of one or several actuators 8, generally hydraulic, at least single-acting, interposed between a reinforcing harness 9 and chassis 2.

At the jib head 10, jib 7 includes means of suspension and orientation 11 of lifting beam 12, which is generally constructed as shown in FIG. 2, by a generally long-shaped box beam 13 which may be moved by an orientation tower 11a, so that its longitudinal axis x-x′ forms any angle, or even a zero angle with the longitudinal axis y-y′ of job 7.

Box beam 13 has two opposed telescopic half-beams 14 adjustable for their spread, generally but not necessarily symmetrically. At the end, each half-beam supports a flange 15, which, as a lifting device, is provided with seizing or attaching locks 16, for instance two of them.

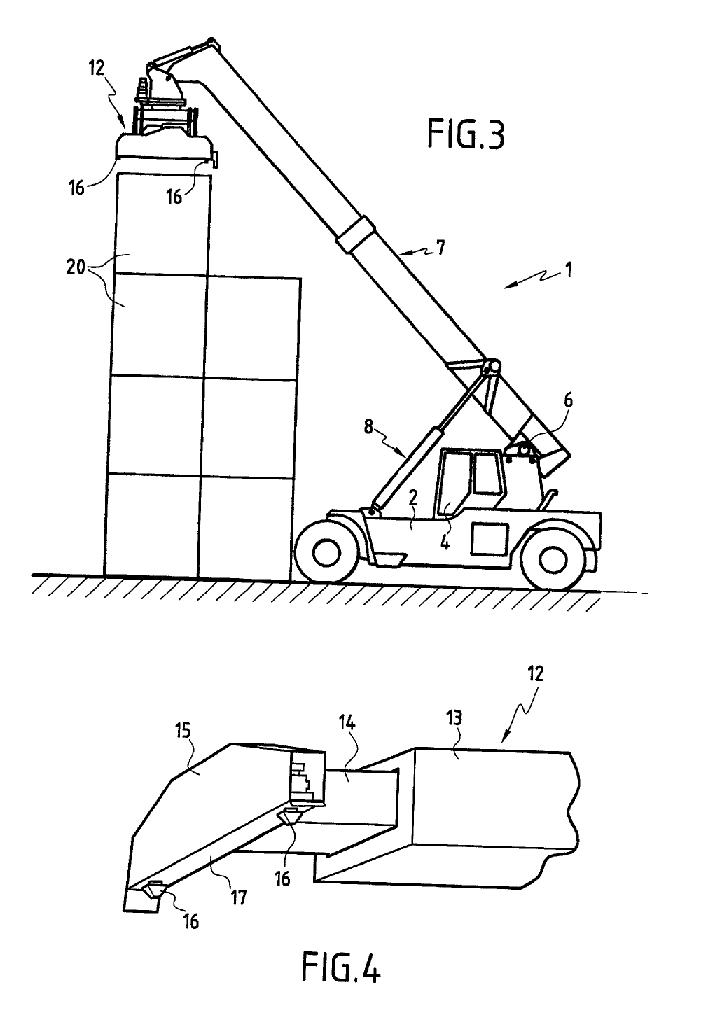

Therefore, lifting beam 12 is adjustable, at least in length, so as to match the gauge of the containers, such as 20, which, as illustrated in FIG. 3, must be lifted and handled to be loaded or off-loaded or stored and stacked in a temporary storage area for instance, the port platform of a sea loading-unloading port.

It is essential to consider the above example as an illustration only, because the purpose of the invention refers to any type of suspension, lifting or handling beam adapted to a suitable supporting structure from which it is necessary to handle a load by suspension.

FIG. 3, in this application, shows that through locks 16 and the appropriate adjustment of the length of jib 7 and its elevator orientation at the least, it is possible to grip and grasp any container 20 to ensure its lifting, transport or even orientation to meet handling requirements. It should be noted that in the working position, container 20 forming the load to be transported is suspended by means of the attaching locks or devices 16 from lifting beam 12.

FIG. 14 shows in greater detail, although schematically, the partial composition of lifting beam 12 from box beam 13 supporting one of the outer half-beams 14, at the end of which is flange 15 extending transversally to the axis of half-beam 14, and whose two ends are provided with two locks 16 turned downward from a reference phase, for instance 17, forming part of flange 15.

As understood by the invention, it should be considered that the constructive characteristic of the lifting beam 12 is part of the knowledge of the man of the art, in the same way as are the slaving devices to be implemented in some cases to ensure the complete functionalities as offered by this type of lifting beam.

It should also be considered that if, under the terms of the drawings and the particular application referred to, a lifting beam like 12 includes, as lifting devices, four gripping or attaching locks 16; some applications may use a different number of locks while remaining within the field of the invention.

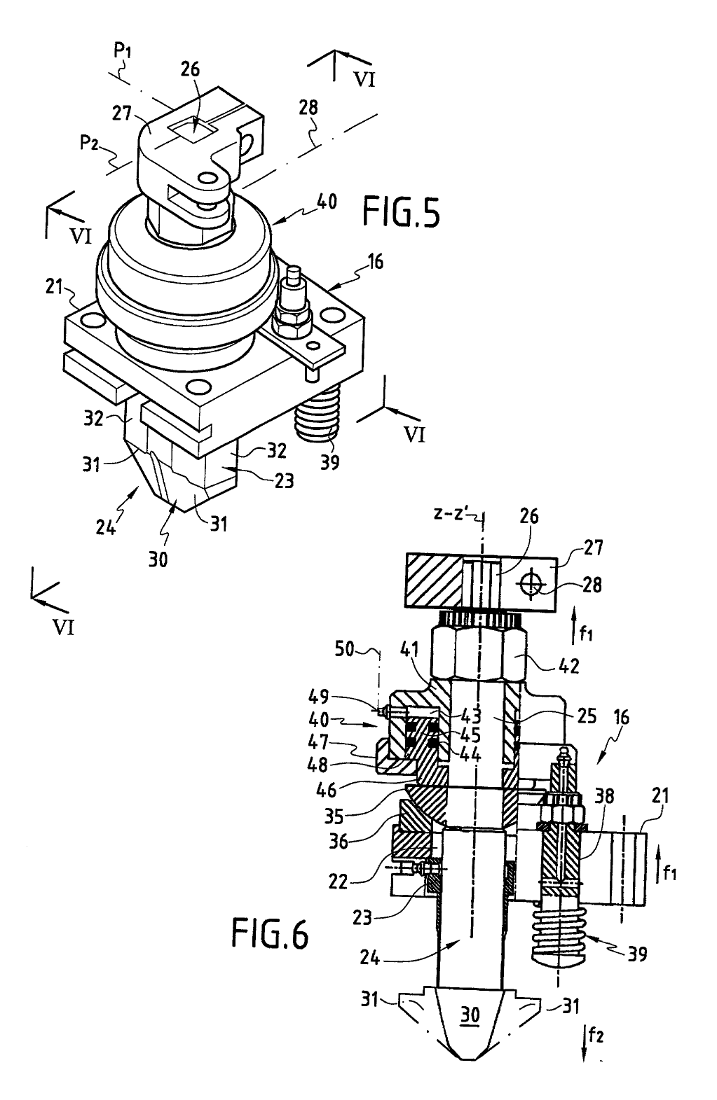

A gripping lock such as 16, includes as shown in FIGS. 5 and 6, attaching plate 21 so that lock 16 is removable with respect to flange 15 in the illustrated example, or with respect to any bearing structure of an equivalent type.

Attaching plate 21 defines a through passage 22 lined with a guide sleeve 23 defining a clear bore for an attaching or gripping device 24 comprising essentially a so-called suspension rod 25, generally cylindrical in shape. Rod 25 passes through opening 22 and includes a first suitable terminal part 26 formed by a coupling end on which is mounted a clevis 27 which, being removable, is suitable for connection to a control transmission 28, generally consisting of a connecting rod or, yet again, by the piston shaft of a pneumatic, hydraulic, electric or mechanical actuator. In the example used in this application, transmission 28 is of the antagonist double-acting type so as to be able to control simultaneously rotation about their axis z-z′ of the rods 25 forming the two locks 15 on each flange.

For reasons appearing from the above, but also known in the technique, transmission 28 is designed to be able to control the rotation of rod 25 through an angular development of approximately 90° from a position P₁, as illustrated in FIG. 5 to a position P₂ and vice versa.

The terminal part of rod 25 opposite end 26 has a gripping or attaching head 30 with two shoulders 31 placed diametrically opposite each other on a common direction at right angles to the z-z′ axis and that are aligned with two extensions 32 of sleeve 23 in the stable idle position P₁, as illustrated in FIG. 5.

In addition, rod 25, through a spherical bearing surface 35, is supported on seat 36 consisting of attaching body 21. Spherical bearing surface 35 is preferably made of an independent part immobilized endwise and angularly on rod 25.

It is advantageous for the attaching body to be completed by a position sensor 38 extending downwards and held to protrude by means of an elastic return device 39.

The function to be provided by this type of lock is to enable head 30 to engage in the oblong mortise shape of the container, such as 20, whose presence is detected by information supplied by position sensor 39.

When head 30 has penetrated, transmission 28 is controlled to rotate the attaching or seizing device 24 from position P₁ to P₂ so that shoulders 21 are then placed under the bearing edges forming the mortise, and thus establishing a link between lock 16 and container 20, as is already known.

According to the invention, at rod 25, it is intended to install a stress sensor working on the traction applied to device 24 in the direction of arrows f₁ and f₂, as soon as attaching body 21 is raised in the direction of arrow f₁, once head 30 has gripped the corresponding mortise of container 20, as already described.

Using a traction stress sensor such as this, it is possible to have precise and localized information independent of the mechanical stresses taken up by the entire bearing structure which are liable to cause quantitative distortions distorting the information supplied by the currently known methods of evaluation.

In an example of the application illustrated in FIG. 6, the stress sensor designed generally by reference 40, is of a fluid compression chamber type. In this type of embodiment, sensor 40 includes a bearing cap 41 which is axially and angularly integral with rod 25, being placed between a bearing head 42 integral with rod 25 and body 21. Cap 41, in its annular transversal face opposite end 26, establishes an annular compression chamber 43 which, with interposed seals 44, fits over annular piston 45 supported by support body 46 linked with attaching body 21, for instance by being made integral with spherical bearing 35. Preferably, the axial link between cap 41 and annular piston 45 is provided by means of socket 47 linked with the cap and bearing under an annular edge 48 presented by piston 45.

The assembly as described above forms chamber 43, referred to as blind in that it has neither an inlet orifice nor an outlet orifice and is completely full of a fluid, such as hydraulic oil, the pressure increase of which can be evaluated by means of measurement linked with the means of remote transmission 50 of the observed pressure variation.

In the situation described above, corresponding to a lifting function, the load transferred onto shoulders 31 of head 30 solicits rod 25 in the direction of arrow f₂ so that head 42 bears on cap 41, which tends to engage annular piston 45 even further. This results in the tendency to reduce the volume in annular chamber 43 and consequently, raise the pressure of the hydraulic fluid which is transmitted, for instance by means 50, to a centralizing device available to the operator in charge of the maneuver in cab 4 of machine 1.

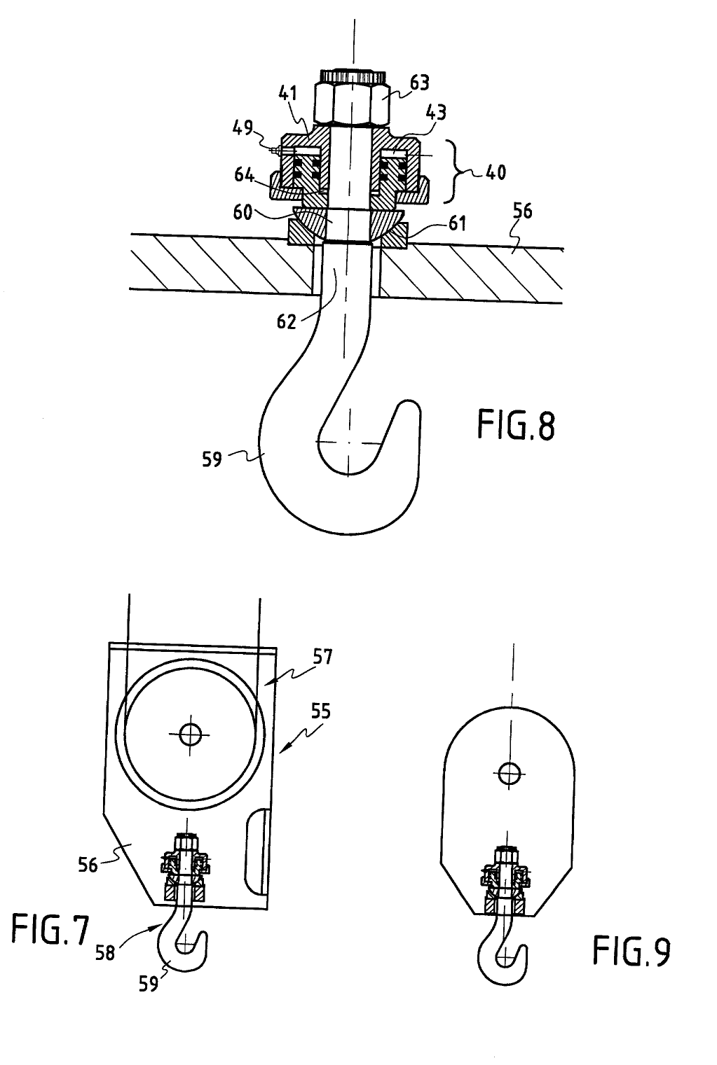

In the previously described examples, stress sensor 40 conforming to the invention is implemented on a lifting device forming an attaching lock for a container lifting-handling machine lifting beam. However, in conformity with the invention, stress sensor 40 can be placed on any other type of lifting device for attaching to any load suspended from a handling machine. Accounting, FIG. 7 is another example of the implementation of stress sensor 40 on a lifting device, generally illustrated by reference 55, forming a sheave lifting hook for a handling crane. Lifting device 55 then includes an attaching body 56 equipped with a sheave system 57. In addition, the attaching body 56 is equipped with an attaching device 58 having a handling hook 59.

As shown more specifically in FIG. 8, attaching body 56 has axial guiding and immobilization means 60, as well as rotation guiding means 61 formed by a spherical bearing surface in the illustration shown. The attaching device 58, in the extension of hook 59, has a rod 62 passing through attaching body 56 and a stress sensor 40 conforming with the invention.

Rod 62 is thus maintained by immobilization and guide facilities 60 and opposite hook 59 has a bearing head 63 resting on cap 41 of stress sensor 40, which also has a structure similar to that described in conjunction with FIG. 6. Also, it should be noted that bearing cap 41 and support 46 are both transversed by bore 64 designed to receive suspension rod 62 of attaching device 58. Note that bore 64 and compression chamber 43 are more or less coaxial.

In the example given, annular chamber 43 is defined by an annular groove provided in the bearing cap in which the piston defined by support body 46 is engaged. However, according to the invention, annular chamber 43 could be defined by an annular groove in support body 46 in which a piston defined by bearing cap 41 could be engaged.

Furthermore, note that according to the invention, the compression chamber is not necessarily annular. Accordingly, in a variant not shown here, stress sensor 40 could have a multitude of compression chambers communicating with one another and set out about bore 64 receiving suspension rod 62 of attaching device 58. Accordingly, stress sensor 40 could have three cylindrical compression chambers arranged at 120° about bore axis 64.

Obviously, any other configuration could be used depending upon the conditions for the implementation of the stress sensor conforming to the invention.

According to the example given in FIG. 7, stress sensor 40 is implemented on a lifting hook equipped with a sheave device 57. Naturally stress sensor 40 can also be implemented on a simple lifting hook system without a sheave device, as illustrated in FIG. 9.

The invention is not confined to the examples described and shown because various modifications can be made while remaining within this framework.

What is claimed is:

1. Stress sensor for a lifting and/or handling device including a lifting device (16) equipped with an attaching (24) for a “suspended” load (20), characterized in that it includes:
a support body (46) and a bearing cap (41) which, together, define at least one fluid compression chamber (43) and are designed to be interposed,
pressure measuring facilities (49) within the compression chamber (43).

2. A stress sensor according to claim 1, characterized in that support body (46) and bearing cap (41) contain a bore designed to accommodate the suspension rod (25) of the attaching device.

3. A stress sensor according to claim 1, characterized in that the compression chamber (43) is filled with a hydraulic fluid.

4. A stress sensor according to claim 3, characterized in that the compression chamber (43) is of the blind type.

5. A stress sensor according to claim 1, characterized in that compression chamber (43) is annular in shape.

6. A stress sensor according to claim 2, characterized in that compression chamber (43) and the receiving bore are coaxial.

7. A stress sensor according to claims 5, characterized in that compression chamber (43) is defined by an annular groove in bearing cap (41) in which an annular piston (45) supported by body (46) is engaged.

8. A stress sensor according to claim 7, characterized in that it includes means (50) of remote transmission of the information supplied by the measurement means.

9. A lifting device for the lifting-handling machine of a type comprising at least one attaching body (21, 56) equipped with an attaching device (24, 58) for a load (20) characterized in that it includes a stress sensor (40) according to claim 1, interposed between attaching body (21) and the attaching device (24).

10. A lifting device according to claim 9, characterized in that it forms weighing lock (16) forming a rotating attachment for a load lifting beam (12) of a lifting-handling machine for a container (20) and whereby:
attaching body (21) includes axial guiding and immobilization means (35, 36) and rotation guiding means (23),
the attaching device (24) includes a rod (25), generally cylindrical, passing through the attaching body (21) and the stress sensor (40), held by guide and immobilization means and which, outside that body, includes a coupling end (26) with an alternate rotation drive transmission (28) and opposite, a shouldered head (30) designed to cooperate with an oblong mortise formed by container (20).

11. A lifting device according to claim 9, characterized in that it forms a crane hook (55) and whereby:
the attaching body (56) has axial guidance and immobilization means and rotation guidance means,
the attaching device (58) includes a hook (59) extending in the form of a rod (62) passing through body (56) and stress sensor (40) while being retained by the immobilization and guiding means (60) and which has, opposite hook (59), a bearing head (63) on cap (41) of stress sensor (40) interposed between attaching body (56) and attaching device (59).
